(19) United States
(12) Patent Application Publication
(10) Pub. No.: US 2011/0280221 A1
(43) Pub. Date: Nov. 17, 2011

(54) Discontinuous Reception (DRX) For Multimode User Equipment (UE) Operation

(76) Inventors: Tom Chin, San Diego, CA (US); Guangming Shi, San Diego, CA (US); Kuo-Chun Lee, San Diego, CA (US)

(21) Appl. No.: 12/884,656

(22) Filed: Sep. 17, 2010

Related U.S. Application Data
(60) Provisional application No. 61/345,248, filed on May 17, 2010.

(51) Int. Cl. H04B 7/216; H04W 4/00

(52) U.S. Cl. 370/335; 455/434

(57) ABSTRACT

In geographical areas with incomplete coverage of Time Division Synchronous Code Division Multiple Access (TD-SCDMA) networks, it may be beneficial for a multimode User Equipment (UE) to register with and monitor paging channels of a Base Transceiver Station (BTS) of a Code Division Multiple Access (CDMA) 1× Radio Transmission Technology (RTT). The UE may monitor the paging channels of the BTS of the CDMA 1× RTT network by entering discontinuous reception (DRX) from the Node B of the TD-SCDMA network. The Node B of the TD-SCDMA network schedules the UE's DRX to coincide with the paging interval appropriate for the UE determined by the UE's IMSI and network time information. After monitoring the paging channel, the UE reacquires the Node B of the TD-SCDMA network and receives data and HARQ transmissions.

### CROSS REFERENCE TO RELATED APPLICATION

This application claims the benefit of U.S. provisional patent application no. 61/345,248 filed May 17, 2010, in the names of CHIN et al., the disclosure of which is expressly incorporated herein by reference in its entirety.

### BACKGROUND

1. Field

Aspects of the present disclosure relate, in general, to wireless communication systems, and more particularly, to multimode user equipment operating on dissimilar networks, such as a Time Division—Synchronous Code Division Multiple Access (TD-SCDMA) network and a Code Division Multiple Access (CDMA) 1× Radio Transmission Technology (RTT) network.

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). For example, China is pursuing TD-SCDMA as the underlying air interface in the UTRAN architecture with its existing GSM infrastructure as the core network. The UMTS also supports enhanced 3G data communications protocols, such as High Speed Downlink Packet Data (HSDPA), which provides higher data transfer speeds and capacity to associated UMTS networks.

As the demand for mobile broadband access continues to increase, research and development continue to advance the UMTS technologies not only to meet the growing demand for mobile broadband access, but to advance and enhance the user experience with mobile communications.

### SUMMARY

In one aspect of the disclosure, a method for communicating in a wireless network includes receiving at least one indication from a Node B (NB) of a first radio access network to enter an idle interval. The method also includes monitoring, during the idle interval, a paging listening interval of a second radio access network.

In another aspect, a computer program product for communicating in a wireless network includes a computer-readable medium having code to receive at least one indication from a Node B (NB) of a first radio access network to enter an idle interval. The medium also includes code to monitor, during the idle interval, a paging listening interval of a second radio access network.

In yet another aspect, an apparatus for communicating in a wireless network includes a processor and a memory coupled to the processor. The processor is configured to receive at least one indication from a Node B (NB) of a first radio access network to enter an idle interval. The processor is also configured to monitor, during the idle interval, a paging listening interval of a second radio access network.

In a further aspect, an apparatus for communicating in a wireless network includes means for receiving at least one indication from a Node B (NB) of a first radio access network to enter an idle interval. The apparatus also includes means for monitoring, during the idle interval, a paging listening interval of a second radio access network.

### BRIEF DESCRIPTION OF THE DRAWINGS

FIG. 1 is a block diagram illustrating an example of a telecommunications system.

FIG. 2 is a block diagram conceptually illustrating an example of a frame structure in a telecommunications system.

FIG. 3 is a block diagram of a Node B in communication with a user equipment in a radio access network.

FIG. 4 is a block diagram illustrating carrier frequencies in a multi-carrier TD-SCDMA communication system.

FIG. 5 illustrates a geographical area with coverage from two radio access networks according to one aspect.

FIG. 6 is a timing diagram showing paging in a CDMA 1× RTT network according to one aspect.

FIG. 7 is a block diagram illustrating an exemplary timing for monitoring physical channels according to one aspect.

FIG. 8 is a timing diagram illustrating the selection of a DRX Offset value according to one aspect.

FIG. 9 is a timing diagram illustrating a prohibit interval according to one aspect.

FIG. 10 is a timing diagram illustrating timing of the UE according to one aspect.

FIG. 11 is a call flow illustrating operations by the UE to monitor paging messages of a CDMA 1× RTT network during discontinuous reception with a TD-SCDMA network according to one aspect.

FIG. 12 is a flow chart for monitoring paging messages of a CDMA 1× network during discontinuous reception with a TD-SCDMA network according to one aspect.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

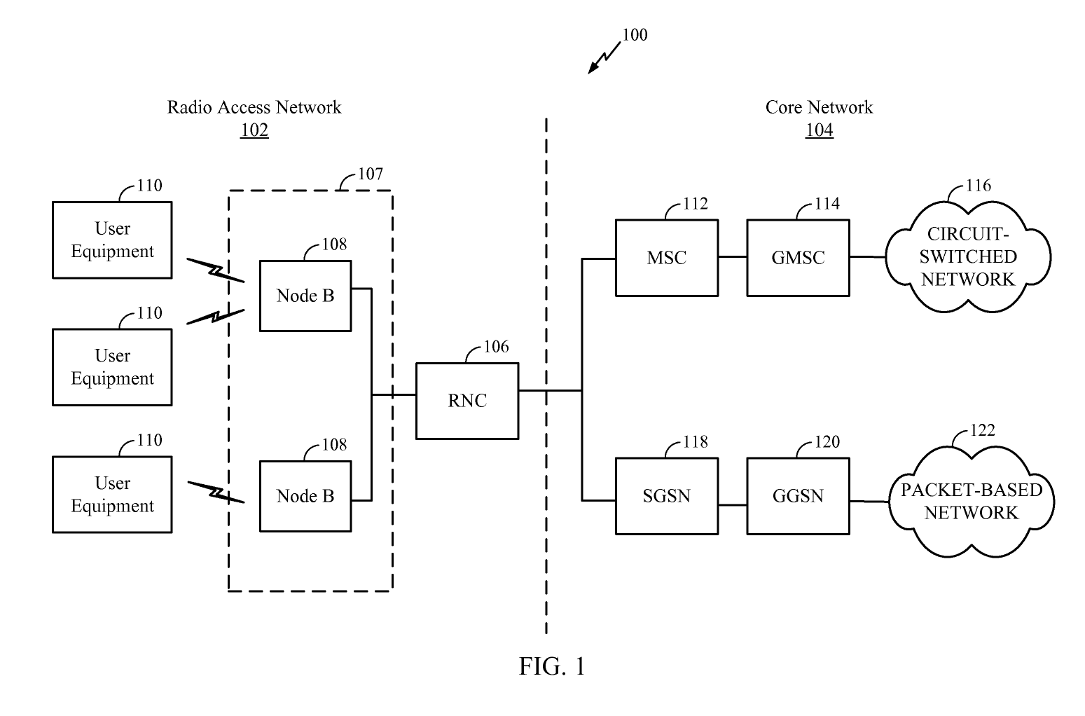

Turning now to FIG. 1, a block diagram is shown illustrating an example of a telecommunications system 100. The various concepts presented throughout this disclosure may be implemented across a broad variety of telecommunication systems, network architectures, and communication standards. By way of example and without limitation, the aspects of the present disclosure illustrated in FIG. 1 are presented with reference to a UMTS system employing a TD-SCDMA standard. In this example, the UMTS system includes a (Radio Access Network) RAN 102 (e.g., UTRAN) that provides various wireless services including telephony, video, data, messaging, broadcasts, and/or other services. The RAN 102 may be divided into a number of Radio Network Subsystems (RNSs), such as an RNS 107, each controlled by a Radio Network Controller (RNC), such as an RNC 106. For clarity, only the RNC 106 and the RNS 107 are shown; however, the RAN 102 may include any number of RNCs and RNSs in addition to the RNC 106 and RNS 107. The RNC 106 is an apparatus responsible for, among other things, assigning, reconfiguring and releasing radio resources within the RNS 107. The RNC 106 may be interconnected to other RNCs (not shown) in the RAN 102 through various types of interfaces, such as a direct physical connection, a virtual network, or the like, using any suitable transport network.

The geographic region covered by the RNS 107 may be divided into a number of cells, with a radio transceiver apparatus serving each cell. A radio transceiver apparatus is commonly referred to as a Node B in UMTS applications, but may also be referred to by those skilled in the art as a Base Station (BS), a Base Transceiver Station (BTS), a radio base station, a radio transceiver, a transceiver function, a Basic Service Set (BSS), an Extended Service Set (ESS), an Access Point (AP), or some other suitable terminology. For clarity, two Node Bs 108 are shown; however, the RNS 107 may include any number of wireless Node Bs. The Node Bs 108 provide wireless access points to a core network 104 for any number of mobile apparatuses. Examples of a mobile apparatus include a cellular phone, a smart phone, a Session Initiation Protocol (SIP) phone, a laptop, a notebook, a netbook, a smartbook, a Personal Digital Assistant (PDA), a satellite radio, a Global Positioning System (GPS) device, a multimedia device, a video device, a digital audio player (e.g., MP3 player), a camera, a game console, or any other similar functioning device. The mobile apparatus is commonly referred to as User Equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an Access Terminal (AT), a mobile terminal, a wireless terminal, a remote terminal, a handset, a terminal, a user agent, a mobile client, a client, or some other suitable terminology. For illustrative purposes, three UEs 110 are shown in communication with the Node Bs 108. The Downlink (DL), also called the forward link, refers to the communication link from a Node B to a UE, and the Uplink (UL), also called the reverse link, refers to the communication link from a UE to a Node B.

The core network 104, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 104 supports circuit-switched services with a mobile switching center (MSC) 112 and a gateway MSC (GMSC) 114. One or more RNCs, such as the RNC 106, may be connected to the MSC 112. The MSC 112 is an apparatus that controls call setup, call routing, and UE mobility functions. The MSC 112 also includes a Visitor Location Register (VLR) (not shown) that contains subscriber-related information for the duration that a UE is in the coverage area of the MSC 112. The GMSC 114 provides a gateway through the MSC 112 for the UE to access a circuit-switched network 116. The GMSC 114 includes a Home Location Register (HLR) (not shown) containing subscriber data, such as the data reflecting the details of the services to which a particular user has subscribed. The HLR is also associated with an Authentication Center (AuC) that contains subscriber-specific authentication data. When a call is received for a particular UE, the GMSC 114 queries the HLR to determine the UE's location and forwards the call to the particular MSC serving that location.

The core network 104 also supports packet-data services with a Serving GPRS Support Node (SGSN) 118 and a Gateway GPRS Support Node (GGSN) 120. GPRS, which stands for General Packet Radio Service, is designed to provide packet-data services at speeds higher than those available with standard GSM circuit-switched data services. The GGSN 120 provides a connection for the RAN 102 to a packet-based network 122. The packet-based network 122 may be the Internet, a private data network, or some other suitable packet-based network. The primary function of the GGSN 120 is to provide the UEs 110 with packet-based network connectivity. Data packets are transferred between the GGSN 120 and the UEs 110 through the SGSN 118, which performs primarily the same functions in the packet-based domain as the MSC 112 performs in the circuit-switched domain.

The UMTS air interface is a spread spectrum Direct-Sequence Code Division Multiple Access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a Time Division Duplexing (TDD), rather than a Frequency Division Duplexing (FDD) as used in many FDD mode UMTS/W-CDMA systems. TDD uses the same carrier frequency for both the Uplink (UL) and Downlink (DL) between a Node B 108 and a UE 110, but divides uplink and downlink transmissions into different time slots in the carrier.

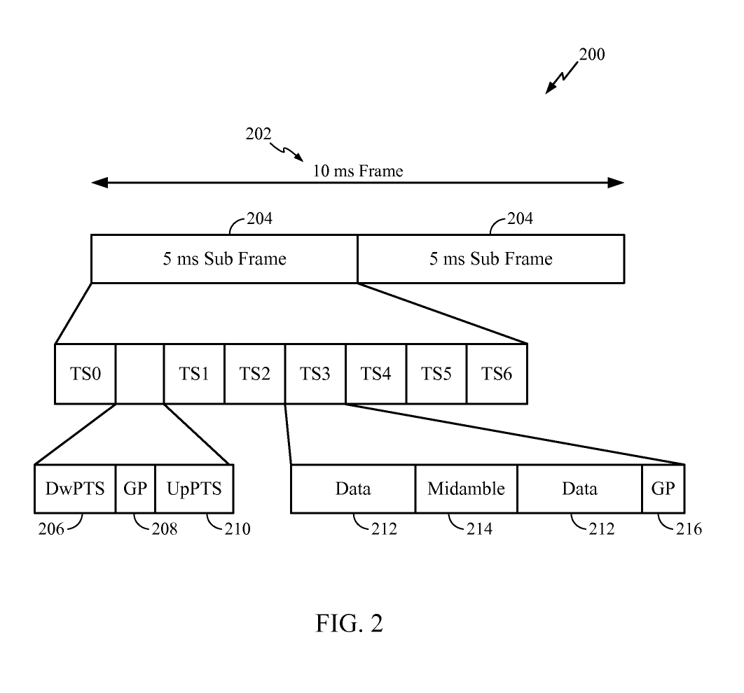

FIG. 2 shows a frame structure 200 for a TD-SCDMA carrier. The TD-SCDMA carrier, as illustrated, has a frame 202 that is 10 ms in length. The frame 202 has two 5 ms subframes 204, and each of the subframes 204 includes seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A Downlink Pilot Time Slot (DwPTS) 206 (also known as the Downlink Pilot Channel (DwPCH)), a guard period (GP) 208, and an Uplink Pilot Time Slot (UpPTS) 210 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 212 separated by a midamble 214 and followed by a Guard Period (GP) 216. The midamble 214 may be used for features, such as channel estimation, while the GP 216 may be used to avoid inter-burst interference.

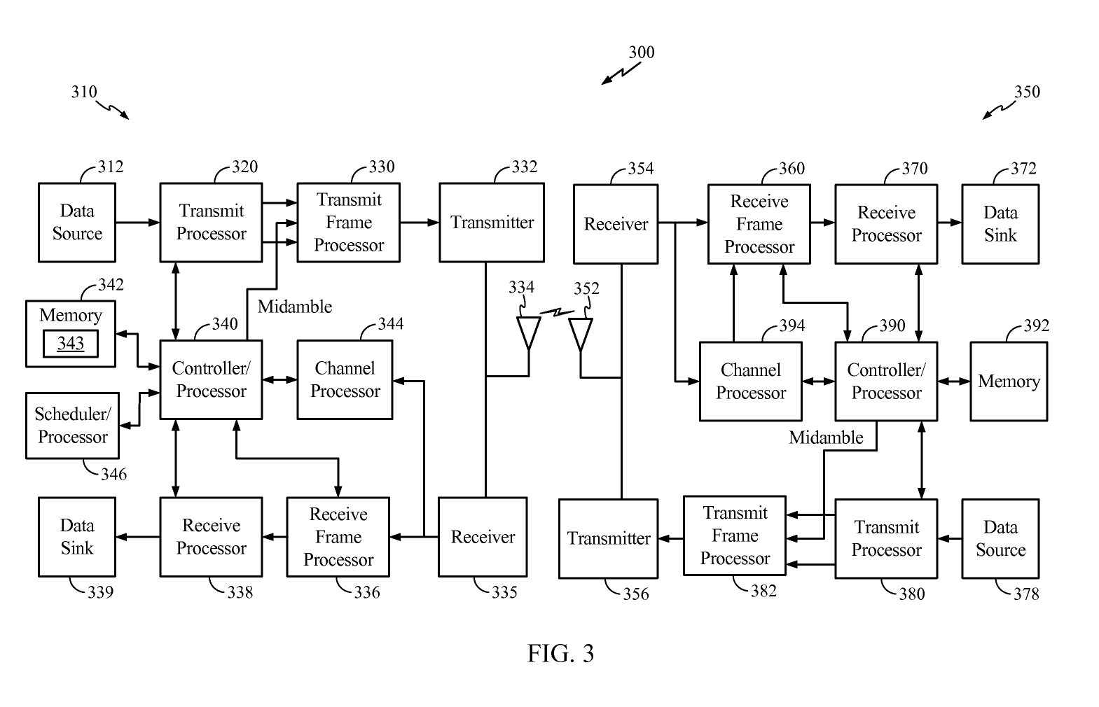

FIG. 3 is a block diagram of a Node B 310 in communication with a UE 350 in a RAN 300, where the RAN 300 may be the RAN 102 in FIG. 1, the Node B 310 may be the Node B 108 in FIG. 1, and the UE 350 may be the UE 110 in FIG. 1. In the downlink communication, a transmit processor 320 may receive data from a data source 312 and control signals from a controller/processor 340. The transmit processor 320 provides various signal processing functions for the data and control signals, as well as reference signals (e.g., pilot signals). For example, the transmit processor 320 may provide Cyclic Redundancy Check (CRC) codes for error detection, coding and interleaving to facilitate Forward Error Correction (FEC), mapping to signal constellations based on various modulation schemes (e.g., Binary Phase-Shift Keying (BPSK), Quadrature Phase-Shift Keying (QPSK), M-Phase-Shift Keying (M-PSK), M-Quadrature Amplitude Modulation (M-QAM), and the like), spreading with Orthogonal Variable Spreading Factors (OVSF), and multiplying with scrambling codes to produce a series of symbols. Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback contained in the midamble 214 (FIG. 2) from the UE 350. The symbols generated by the transmit processor 320 are provided to a transmit frame processor 330 to create a frame structure. The transmit frame processor 330 creates this frame structure by multiplexing the symbols with a midamble 214 (FIG. 2) from the controller/processor 340, resulting in a series of frames. The frames are then provided to a transmitter 332, which provides various signal conditioning functions including amplifying, filtering, and modulating the frames onto a carrier for downlink transmission over the wireless medium through smart antennas 334. The smart antennas 334 may be implemented with beam steering bidirectional adaptive antenna arrays or other similar beam technologies.

At the UE 350, a receiver 354 receives the downlink transmission through an antenna 352 and processes the transmission to recover the information modulated onto the carrier. The information recovered by the receiver 354 is provided to a receive frame processor 360, which parses each frame, and provides the midamble 214 (FIG. 2) to a channel processor 394 and the data, control, and reference signals to a receive processor 370. The receive processor 370 then performs the inverse of the processing performed by the transmit processor 320 in the Node B 310. More specifically, the receive processor 370 descrambles and despreads the symbols, and then determines the most likely signal constellation points transmitted by the Node B 310 based on the modulation scheme. These soft decisions may be based on channel estimates computed by the channel processor 394. The soft decisions are then decoded and deinterleaved to recover the data, control, and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receiver processor 370, the controller/processor 390 may also use an Acknowledgement (ACK) and/or Negative Acknowledgement (NACK) protocol to support retransmission requests for those frames.

In the uplink, data from a data source 378 and control signals from the controller/processor 390 are provided to a transmit processor 380. The data source 378 may represent applications running in the UE 350 and various user interfaces (e.g., keyboard, pointing device, track wheel, and the like). Similar to the functionality described in connection with the downlink transmission by the Node B 310, the transmit processor 380 provides various signal processing functions including CRC codes, coding and interleaving to facilitate FEC, mapping to signal constellations, spreading with OVSFs, and scrambling to produce a series of symbols. Channel estimates, derived by the channel processor 394 from a reference signal transmitted by the Node B 310 or from feedback contained in the midamble transmitted by the Node B 310, may be used to select the appropriate coding, modulation, spreading, and/or scrambling schemes. The symbols produced by the transmit processor 380 will be provided to a transmit frame processor 382 to create a frame structure. The transmit frame processor 382 creates this frame structure by multiplexing the symbols with a midamble 214 (FIG. 2) from the controller/processor 390, resulting in a series of frames. The frames are then provided to a transmitter 356, which provides various signal conditioning functions including amplification, filtering, and modulating the frames onto a carrier for uplink transmission over the wireless medium through the antenna 352.

The uplink transmission is processed at the Node B 310 in a manner similar to that described in connection with the receiver function at the UE 350. A receiver 335 receives the uplink transmission through the smart antennas 334 and processes the transmission to recover the information modulated onto the carrier. The information recovered by the receiver 335 is provided to a receive frame processor 336, which parses each frame, and provides the midamble 214 (FIG. 2) to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor 340, respectively. If some of the frames were unsuccessfully decoded by the receive processor 338, the controller/processor 340 may also use an Acknowledgement (ACK) and/or Negative Acknowledgement (NACK) protocol to support retransmission requests for those frames.

The controller/processors 340 and 390 may be used to direct the operation at the Node B 310 and the UE 350, respectively. For example, the controller/processors 340 and 390 may provide various functions including timing, peripheral interfaces, voltage regulation, power management, and other control functions. The computer readable media of memories 342 and 392 may store data and software for the Node B 310 and the UE 350, respectively. For example, the memory 342 of the Node B 310 includes a handover module 343, which, when executed by the controller/processor 340, the handover module 343 configures the Node B to perform handover procedures from the aspect of scheduling and transmission of system messages to the UE 350 for implementing a handover from a source cell to a target cell. A scheduler/processor 346 at the Node B 310 may be used to allocate resources to the UEs and schedule downlink and/or uplink transmissions for the UEs not only for handovers, but for regular communications as well.

In order to provide more capacity, the TD-SCDMA system may allow multiple carrier signals or frequencies. Assuming that N is the total number of carriers, the carrier frequencies may be represented by the set {F(i), i=0, 1, . . . , N−1}, where the carrier frequency, F(0), is the primary carrier frequency and the rest are secondary carrier frequencies. For example, a cell can have three carrier signals whereby the data can be transmitted on some code channels of a time slot on one of the three carrier signal frequencies.

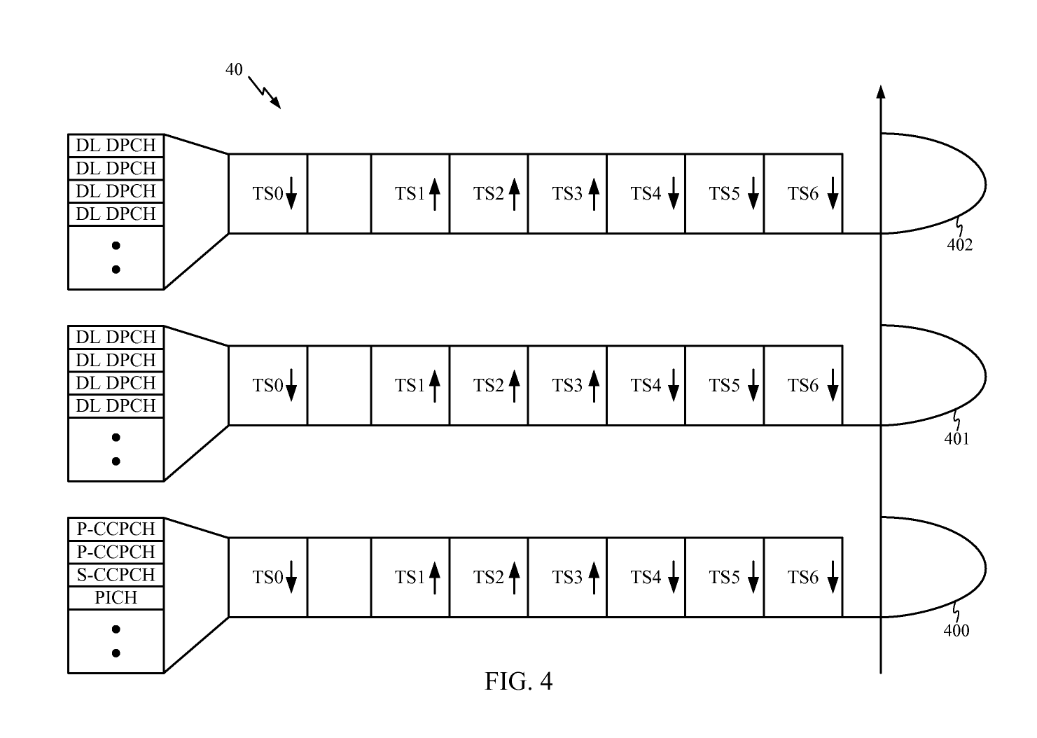

FIG. 4 is a block diagram illustrating carrier frequencies 40 in a multi-carrier TD-SCDMA communication system. The multiple carrier frequencies include a primary carrier frequency 400 (F(0)), and two secondary carrier frequencies 401 and 402 (F(1) and F(2)). In such multi-carrier systems, the system overhead may be transmitted on the first time slot (TS0) of the primary carrier frequency 400, including the Primary Common Control Physical Channel (P-CCPCH), the Secondary Common Control Physical Channel (S-CCPCH), the Paging Indicator Channel (PICH), and the like. The traffic channels may then be carried on the remaining time slots (TS1-TS6) of the primary carrier frequency 400 and on the secondary carrier frequencies 401 and 402. Therefore, in such configurations, a UE will receive system information and monitor the paging messages on the primary carrier frequency 400 while transmitting and receiving data on either one or all of the primary carrier frequency 400 and the secondary carrier frequencies 401 and 402.

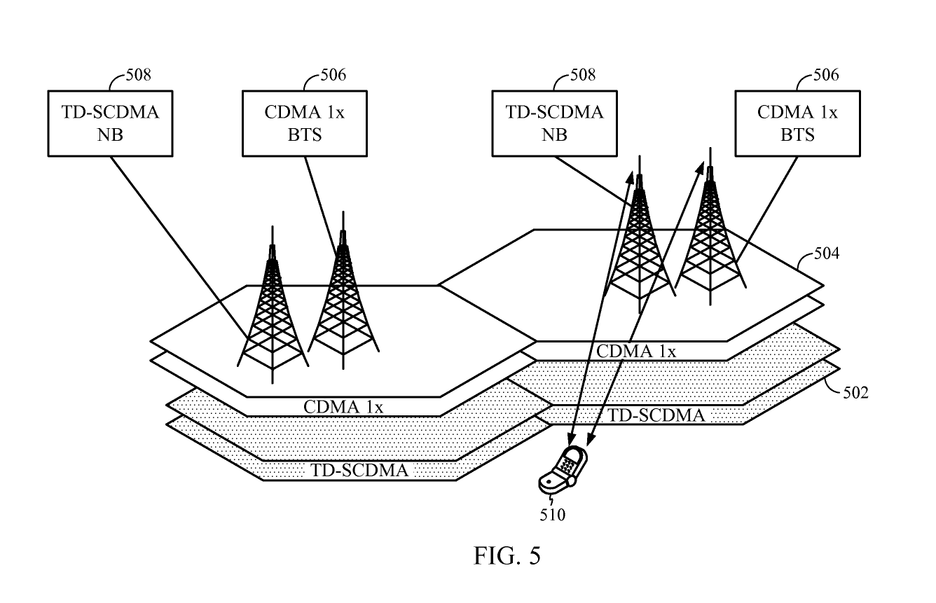

Deployment of a TD-SCDMA network may not provide complete geographic coverage in certain areas. In areas where TD-SCDMA networks are deployed, other networks (such as CDMA 1× RTT (Radio Transmission Technology)) may have a geographical presence. FIG. 5 illustrates a geographical area with coverage from two radio access networks according to one aspect. A first network coverage 502 overlaps with a second network coverage 504. In one aspect, the first network coverage 502 is a TD-SCDMA network, and the second network coverage 504 is a CDMA 1× network. Thus, a multimode UE 510 may benefit from being able to register with both the TD-SCDMA network and the CDMA 1× RTT network. According to one aspect, the multimode UE 510 registers with a TD-SCDMA Node B (NB) 508 and a CDMA 1× RTT Base Transceiver Station (BTS) 506. For example, the multimode UE 510 may have two Subscriber Identity Modules (SIMs): one SIM for CDMA 1× RTT and one SIM for TD-SCDMA.

When the multimode UE 510 is registered with the TD-SCDMA network Node B 508 and the CDMA 1× RTT network BTS 506, the UE 510 may periodically monitor the CDMA 1× RTT paging messages while sending data on High Speed Packet Access (HSPA) channels of the TD-SCDMA network. Some multimode UEs have only a single Radio Frequency (RF) chain for transmitting and receiving on a Radio Access Technologies (RAT) such as TD-SCDMA and CDMA 1× RTT. That is, at any particular time a multimode UE may only be able to access one radio access network of the two radio access networks to which the UE is registered.

Thus, there is a need for a multimode UE capable of monitoring a paging listening interval of a second radio access network while accessing a first radio access network.

In a CDMA 1× RTT network, a Mobile Station (MS) (or UE) listens to a recurrent paging listening interval of a paging cycle in idle slotted modes. The paging listening interval may include an 80 millisecond Paging Channel (PCH) interval and an 80 millisecond Quick Paging Channel (QPCH) interval. The QPCH interval precedes the PCH interval by 100 milliseconds, such that the total paging interval is 180 milliseconds. The MS monitors for paging messages for 180 milliseconds during each paging cycle.

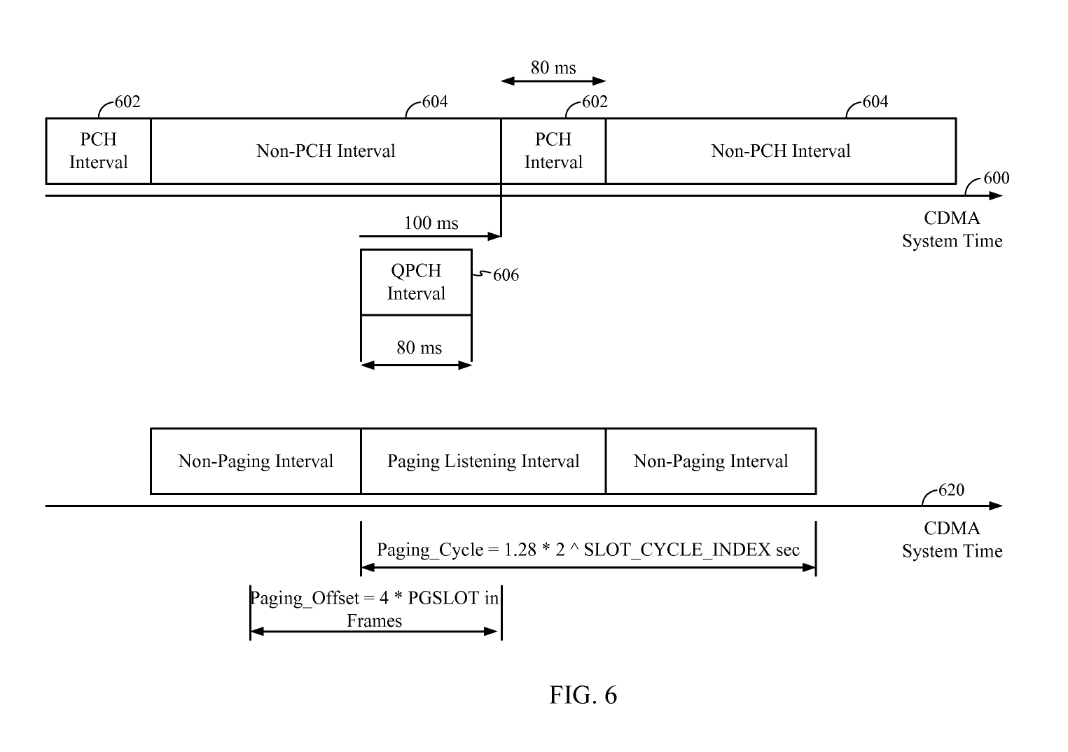

FIG. 6 is a timing diagram showing paging in a CDMA 1× RTT network according to one aspect. A timeline 600 illustrates events at a BTS of a CDMA 1× RTT network, and a timeline 620 illustrates events at a MS of a CDMA 1× RTT network. A BTS of a CDMA 1×RTT network transmits PCH intervals 602 for the MS followed by non-PCH intervals 604 during which there is no PCH transmitted to the MS. A QPCH interval 606 precedes the PCH interval 602 by 100 milliseconds and lasts for 80 milliseconds.

The MS may begin monitoring the PCH starting at a time offset (in units of CDMA 1× RTT frames) of

4*PGSLOT=t mod [64*(2^{SLOT}^{_{—}}^{CYCLE}^{_{—}}^{INDEX})].

Each MS communicating with a BTS of a CDMA 1× RTT network has a different PGSLOT. The PGSLOT may be, for example, a hashed function of the MS's International Mobile Station Identifier (IMSI). Thus the PGSLOT may be spread out based on various mobile stations' IMSI and paging may be spread out over time. The SLOT_CYCLE_INDEX parameter may be an integer between 0 and 7. The SLOT_CYCLE_INDEX is provisioned at the MS, but the Base Station (BS) of the CDMA 1× RTT network may limit the maximum value of SLOT_CYCLE_INDEX by broadcasting a SLOT_CYCLE_INDEX in a System Parameter Message (SPM). The SLOT_CYCLE_INDEX also defines a paging cycle interval as 1.28*2^{SLOT}^{_{—}}^{CYCLE}^{_{—}}^{INDEX} seconds.

3rd Generation Partnership Project (3GPP) Release 8 supports Control Channel Discontinuous Reception (DRX) for high speed downlink packet access (HSDPA) and high speed uplink packet access (HSUPA) operations. Control Channel DRX may be enabled on the UE by the UE receiving Radio Resource Control (RRC) messages such as physical channel reconfiguration, radio bearer reconfiguration, radio bearer release, radio bearer setup, and/or transport channel reconfiguration. Control Channel DRX may be disabled on the UE by the UE receiving a command to deactivate Control Channel DRX on a High-Speed Shared Control Channel (HS-SCCH). After Control Channel DRX is disabled on the UE, the UE may resume normal continuous data transmission on the TD-SCDMA network.

In Control Channel DRX for HSDPA and HSUPA operation, a User Equipment (UE) monitors physical channels only during certain periods. A period for the UE to monitor the High-Speed Shared Control Channel (HS-SCCH) is defined by a HS-SCCH DRX Cycle (1, 2, 4, 8, 16, 32, or 64 subframes) and a HS-SCCH DRX Offset (between 0 and 63 subframes). The High-Speed Shared Control Channel (HS-SCCH) is monitored to indicate a Modulation and Coding Scheme (MCS) as well as a channelization code and timeslot (TS) resource information for a data burst in the High-Speed Physical Downlink Shared Channel (HS-PDSCH).

The UE also monitors an Enhanced Dedicated Channel (E-DCH) Absolute Grant Channel (E-AGCH) on the downlink TSs to indicate the uplink absolute grant control information. A period for the UE to monitor the E-AGCH is defined by a E-AGCH Cycle (1, 2, 4, 8, 16, 32, 64 subframes) and a E-AGCH DRX Offset (between 0 and 63 subframes).

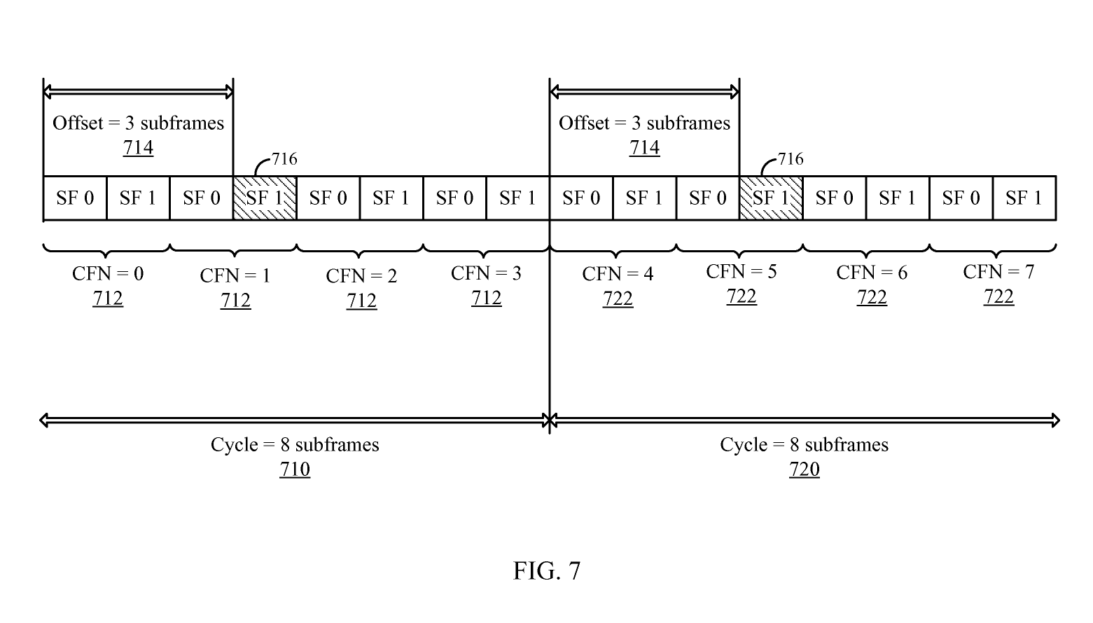

FIG. 7 shows an exemplary timing for monitoring physical channels in accordance with a Control Channel DRX. In this example, the E-AGCH DRX Cycle and the HS-SCCH DRX Cycle are both eight subframes. That is, a first cycle 710 having eight subframes is followed by a second cycle 720 having eight subframes. Although only two cycles are shown, the subframe arrangement shown for the cycles 710, 720 may continue for many more cycles. Each cycle 710, 720 is divided into four connection frame numbers (CFNs) 712, 722. Each connection frame number 712, 722 includes two subframes, SF0 and SF1. In this example, the HS-SCCH DRX Offset and the E-AGCH DRX Offset are both three subframes. Thus, in each cycle after an offset 714 of three subframes, the UE monitors at subframe 716 the physical channels, HS-SCCH and E-AGCH.

In FIG. 7, the HS-SCCH and E-AGCH monitoring occurs in connection frame number 1, subframe 1 of the first cycle. In general, physical channel monitoring occurs in the fourth subframe 716 of each eight subframe cycle 710, 720, i.e., after the three frame offset 714. If there is no activity (i.e., no allocation on the HS-SCCH for the UE) a certain number of subframes (e.g., Inactivity_Threshold_for_HS-SCCH DRX cycle subframes) after transmitting, for example, a Hybrid Automatic Repeat Request (HARQ) Acknowledgement/Negative Acknowledgement (ACK/NACK) on the High-Speed Shared Information Channel (HS-SICH), then the UE may start HSDPA DRX and may power down until the next cycle. At the offset 714 in the next cycle 720, the UE will power up, and then monitor again in that next cycle 720 at the fourth subframe 716. If there is no activity (e.g., no allocation on the E-AGCH for the UE a predetermined number of subframes (e.g., E-AGCH_Inactivity_Monitor_Threshold_subframes)) after receiving a HARQ ACK/NACK on the DCH Hybrid ARQ Acknowledgement Indicator Channel (E-HICH) for the Node B, then the UE may start HSUPA DRX and for example power down until the next offset 714. At the next offset 714, the UE will power up, and then monitor again in that next cycle.

The CFNs for a particular UE may be set by the formula

CFN=(SFN−DOFF) modulo 256

where SFN is the system frame number of the Node B in the TD-SCDMA network, and DOFF (default offset) is a variable sent to the UE in an RRC message for RRC connection setup. The DRX schedule based on CFN may maintain the same absolute time schedule during handover between Node Bs of the TD-SCDMA network that do not have synchronous SFNs because the SFN in the above equation is referenced to the Node B upon initial establishment of the connection.

According to one aspect, the control channel DRX of a TD-SCDMA network is configured to allow time for the UE to monitor the paging messages of a CDMA 1× RTT network. A Node B of the TD-SCDMA network determines the IMSI of the UE from, for example, the Home Location Register (HLR). The Node B of the TD-SCDMA network also determines the system time of the CDMA 1× RTT network by use of the Global Position System (GPS). From the system time and the IMSI, the Node B of the TD-SCDMA network determines the SFN when the multimode UE should start monitoring the Quick Paging Channel (QPCH). In the first example described below, the DOFF value is assumed to be zero.

The Node B of the TD-SCDMA network configures an HS-SCCH/E-AGCH DRX Cycle to have a minimum length of the sum of the time to monitor CDMA 1× paging messages (e.g., 36 subframes or 180 milliseconds), the Inactivity_Threshold (time to wait before beginning DRX), time to tune to the CDMA 1× network (D1), and time to tune to the TD-SCDMA network (D2). According to one aspect, 256 is divisible by the selected DRX cycle.

The Node B of the TD-SCDMA network also configures the HS-SCCH/E-AGCH DRX Offset to allow the UE to return to the TD-SCDMA network. The HS-SCCH/E-AGCH DRX Offset may be the sum of the system frame number of the UE's paging message on the QPCH (SFN_CDMA_QPCH), D2, and the time to monitor CDMA 1× paging messages, modulo the HS-SCCH/E-AGCH DRX Cycle.

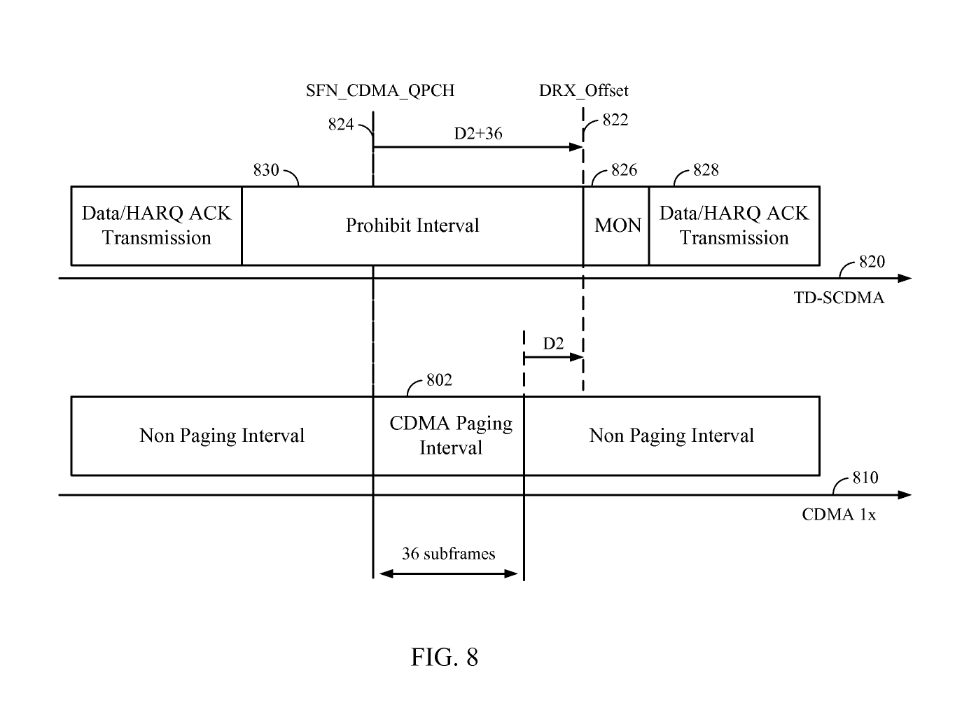

FIG. 8 is a timing diagram illustrating the selection of the HS-SCCH/E-AGCH DRX

Offset value according to one aspect. The Node B of the TD-SCDMA network determines the start of the CDMA paging interval 802 on the CDMA 1× RTT network time 810 as SFN_CDMA_QPCH 824 for the UE based on the UE's IMSI and GPS time. The HS-SCCH/E-AGCH DRX Offset (or DRX_Offset) 822 for the TD-SCDMA network time 820 is then calculated as D2+36 subframes after SFN_CDMA_QPCH. After the DRX Offset, the UE monitors the physical channels (e.g., HS-SCCH/E-AGCH) of the TD-SCDMA at block 826 and resumes data transmission at block 828. During the prohibit interval 830, the Node B of the TD-SCDMA network prohibits data and HARQ ACK/NACK transmission to the UE. The prohibit interval 830 may be the sum of the number of subframes for monitoring the paging channel of the CDMA 1× RTT network (e.g., 36 subframes), the Inactivity_Threshold, D1, and D2. Scheduling data and HARQ ACK transmission before the prohibit interval 830 allows the UE to begin DRX such that the UE may monitor paging messages of the CDMA 1× RTT network.

In one case, the DOFF value is non-zero, a different offset is computed according to the offset calculated above for DOFF=0 minus the DOFF value, all modulo HS-SCCH/E-AGCH DRX Period. That is:

DRX_Offset′=(DRX_Offset−DOFF) modulo DRX Cycle.

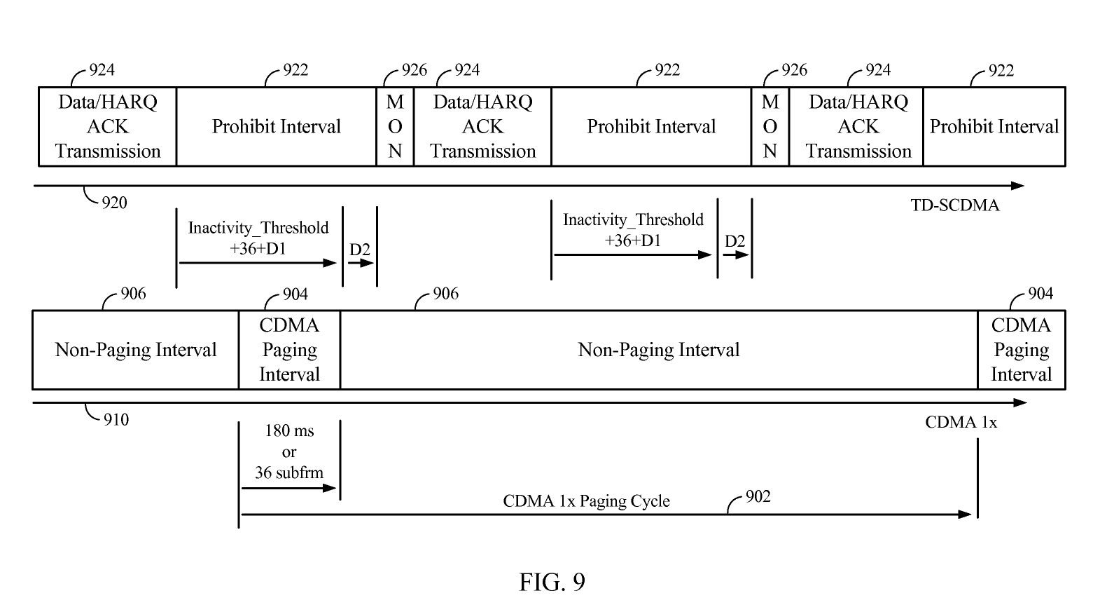

FIG. 9 is a timing diagram illustrating the prohibit interval according to one aspect. A paging cycle 902 of a CDMA 1× RTT network timeline 910 includes a CDMA paging interval 904 for a UE and a non-paging interval 906 for the UE. The CDMA paging interval 904 may be 36 subframes in length or 180 milliseconds. The CDMA paging interval 904 aligns with a prohibit interval 922 of a TD-SCDMA timeline 920. The prohibit interval 922 may have a length the sum of the Inactivity_Threshold, 36 subframes, D1, and D2. After the prohibit interval 922, the UE monitors physical channels of the TD-SCDMA network during a monitor block 926 and transmits data during a data block 924.

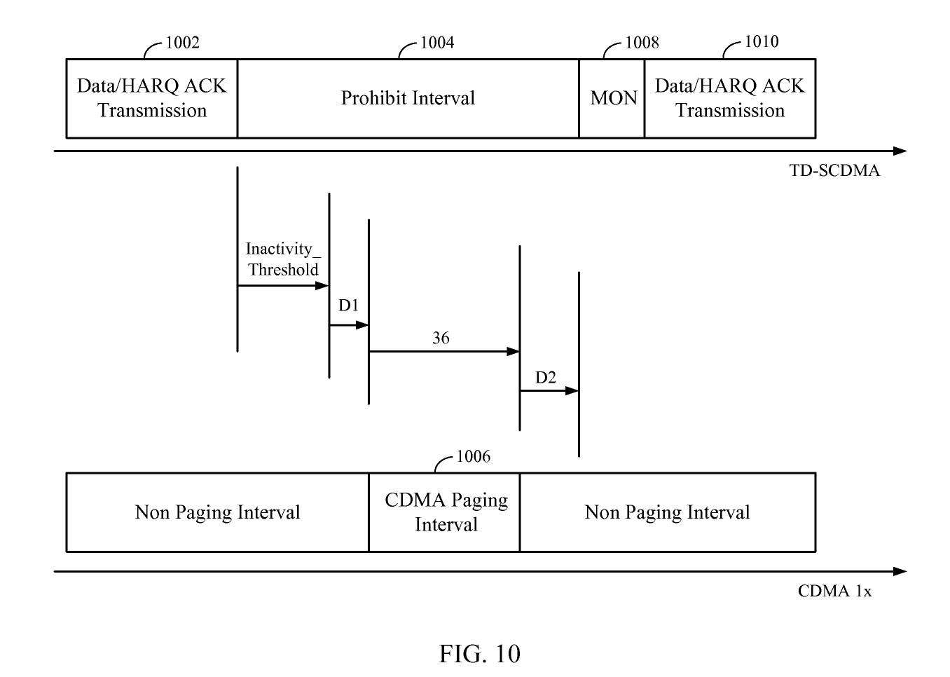

FIG. 10 is a timing diagram illustrating timing of the UE according to one aspect. A UE receives data and HARQ ACK transmission from a Node B of a TD-SCDMA network in block 1002. At block 1004 the Node B of the TD-SCDMA network enters a prohibit interval and discontinues transmission to the UE. During the prohibit interval 1004, the UE waits for an Inactivity_Threshold time to occur before beginning DRX. After the Inactivity_Threshold the UE acquires the BTS of the CDMA 1× RTT network during interval D1, then receives and monitors the CDMA paging messages during the CDMA paging interval 1006, which is equivalent to approximately 36 TD-SCDMA subframes or 180 milliseconds. For example, the UE may monitor the QPCH and PCH. According to one aspect, in a Wideband Code Division Multiple Access (W-CDMA) network, a UE may monitor a paging indicator channel and a paging channel. After receiving the paging messages, the UE acquires the Node B of the TD-SCDMA network during interval D2. The UE then monitors the physical channels of the Node B of the TD-SCDMA network during monitor block 1008 and receives data and HARQ ACK during transmission block 1010.

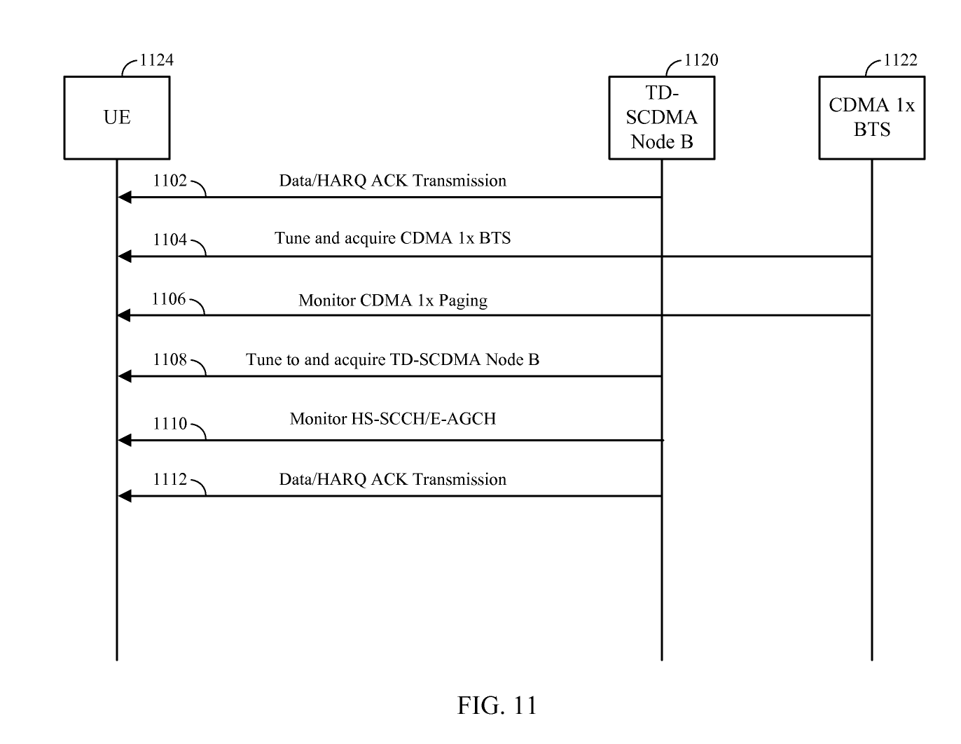

FIG. 11 is a call flow illustrating operations by the UE to monitor paging messages of a CDMA 1× RTT network during discontinuous reception with a TD-SCDMA network according to one aspect. At time 1102, a UE 1124 receives data and HARQ ACK transmission from a Node B of a TD-SCDMA network 1120. At time 1104 the UE 1124 tunes and acquires a BTS of a CDMA 1× RTT network 1122. At time 1106 the UE 1124 monitors the paging channels of the BTS of the CDMA 1× RTT network 1122. At time 1108 the UE 1124 tunes to and acquires the Node B of the TD-SCDMA network 1120. At time 1110 the UE 1124 monitors the physical channels of the Node B of the TD-SCDMA network 1120. At time 1112 the UE 1124 receives data and HARQ ACK transmission from the Node B of the TD-SCDMA network 1120.

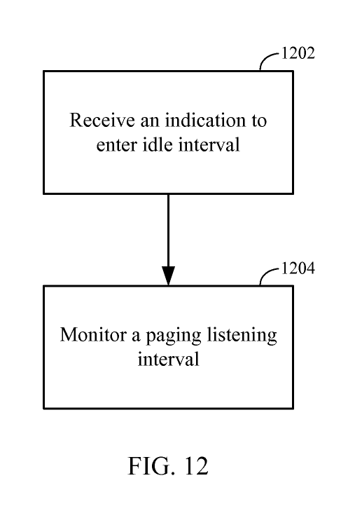

FIG. 12 is a flow chart for monitoring paging messages of a CDMA 1× network during discontinuous reception with a TD-SCDMA network according to one aspect. At block 1202 a UE receives at least one indication from a Node B (NB) of a first radio access network to enter an idle interval. At block 1204 the UE monitors, during the idle interval, a paging listening interval of a second radio access network.

A multimode UE may maintain registration with two radio access networks. The UE may have data transmission while monitoring the paging messages when the UE's discontinuous reception (DRX) mode on a first radio access network is aligned to allow the UE to monitor paging channels on a second radio access network. For example, a UE may be registered with a TD-SCDMA network for data transmission and registered with a CDMA 1×RTT network monitoring the paging messages for the incoming voice call.

Several aspects of a telecommunications system has been presented with reference to TD-SCDMA and CDMA 1× RTT systems. As those skilled in the art will readily appreciate, various aspects described throughout this disclosure may be extended to other telecommunication systems, network architectures and communication standards. By way of example, various aspects may be extended to other UMTS systems such as W-CDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), Global System for Mobile Communications (GSM), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, Digital Signal Processor (DSP), a Field-Programmable Gate Array (FPGA), a Programmable Logic Device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. A computer-readable medium may include, by way of example, memory such as a magnetic storage device (e.g., hard disk, floppy disk, magnetic strip), an optical disk (e.g., Compact Disc (CD), Digital Versatile Disc (DVD)), a smart card, a flash memory device (e.g., card, stick, key drive), Random Access Memory (RAM), Read Only Memory (ROM), Programmable ROM (PROM), Erasable PROM (EPROM), Electrically Erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method for communicating in a wireless network, comprising:
receiving at least one indication from a Node B (NB) of a first radio access network to enter an idle interval; and
monitoring, during the idle interval, a paging listening interval of a second radio access network.

2. The method of claim 1, wherein the monitoring the paging listening interval coincides with a paging period of the second radio access network.

3. The method of claim 1, wherein the idle interval is an idle interval of a high speed channel.

4. The method of claim 1, wherein the first radio access network and the second radio access network occupy different frequencies.

5. The method of claim 1, further comprising receiving an indication to monitor the paging listening interval of the second radio access network.

6. The method of claim 1, wherein the paging listening interval comprises a Paging Channel (PCH) and a Quick Paging Channel (QPCH).

7. The method of claim 1, wherein the first radio access network is a Time Division-Synchronized Code Division Multiple Access (TD-SCDMA) network and the second radio access network is a Code Division Multiple Access (CDMA) 1× Radio Transmission Technology (RTT) network.

8. A computer program product for communicating in a wireless network, comprising:
a computer-readable medium comprising:
code to receive at least one indication from a Node B (NB) of a first radio access network to enter an idle interval; and
code to monitor, during the idle interval, a paging listening interval of a second radio access network.

9. The computer program product of claim 8, wherein the code to monitor the paging listening interval monitors during a paging period of the second radio access network.

10. The computer program product of claim 8, wherein the code to monitor monitors during an idle interval of a high speed channel.

11. The computer program product of claim 8, wherein the code to receive receives on a first frequency and the code to monitor monitors on a second frequency different from the first frequency.

12. The computer program product of claim 8, wherein the medium further comprises code to receive an indication to monitor the paging listening interval of the second radio access network.

13. The computer program product of claim 8, wherein the code to monitor the paging listening interval monitors a Paging Channel (PCH) and a Quick Paging Channel (QPCH).

14. The computer program product of claim 8, wherein the first radio access network is a Time Division-Synchronized Code Division Multiple Access (TD-SCDMA) network and the second radio access network is a Code Division Multiple Access (CDMA) 1× Radio Transmission Technology (RTT) network.

15. An apparatus for communicating in a wireless network, comprising:
at least one processor; and
a memory coupled to the at least one processor,
wherein the at least one processor is configured:
to receive at least one indication from a Node B (NB) of a first radio access network to enter an idle interval; and
to monitor, during the idle interval, a paging listening interval of a second radio access network.

16. The apparatus of claim 15, wherein the at least one processor is configured to monitor the paging listening interval during a paging period of the second radio access network.

17. The apparatus of claim 15, wherein the at least one processor is configured to monitor the paging listening interval during an idle interval of a high speed channel.

18. The apparatus of claim 15, wherein the at least one processor is configured to receive on a first frequency and the at least one processor is configured to monitor on a second frequency different from the first frequency.

19. The apparatus of claim 15, wherein the at least one processor is further configured to receive an indication to monitor the paging listening interval of the second radio access network.

20. The apparatus of claim 15, wherein the at least one processor is configured to monitor during the paging listening interval a Paging Channel (PCH) and a Quick Paging Channel (QPCH).

21. The apparatus of claim 15, wherein the first radio access network is a Time Division-Synchronized Code Division Multiple Access (TD-SCDMA) network and the second radio access network is a Code Division Multiple Access (CDMA) 1× Radio Transmission Technology (RTT) network.

22. An apparatus for communicating in a wireless network, comprising:
means for receiving at least one indication from a Node B (NB) of a first radio access network to enter an idle interval; and
means for monitoring, during the idle interval, a paging listening interval of a second radio access network.

23. The apparatus of claim 22, wherein the monitoring means monitors the paging listening interval during a time coinciding with a paging period of the second radio access network.

24. The apparatus of claim 22, wherein the monitoring means monitors during an idle interval of a high speed channel.

25. The apparatus of claim 22, wherein the receiving means receives on a first frequency and the monitoring means monitors on a second frequency different from the first frequency.

26. The apparatus of claim 22, wherein the monitoring means monitors a Paging Channel (PCH) and a Quick Paging Channel (QPCH).

27. The apparatus of claim 22, wherein the first radio access network is a Time Division-Synchronized Code Division Multiple Access (TD-SCDMA) network and the second radio access network is a Code Division Multiple Access (CDMA) 1× Radio Transmission Technology (RTT) network.
